(19) United States
(12) Patent Application Publication
(10) Pub. No.: US 2024/0194213 A1
(43) Pub. Date: Jun. 13, 2024

(54) Audio Source Separation using Hyperbolic Embeddings

(71) Applicant: Mitsubishi Electric Research Laboratories, Inc., Cambridge, MA (US)

(72) Inventors: Gordon Wichern, Cambridge, MA (US); Jonathan Le Roux, Cambridge, MA (US); Darius Petermann, Cambridge, MA (US); Aswin Shanmugam Subramanian, Cambridge, MA (US)

(21) Appl. No.: 18/191,417

(22) Filed: Mar. 28, 2023

Related U.S. Application Data
(60) Provisional application No. 63/386,472, filed on Dec. 7, 2022.

(51) Int. Cl. G10L 21/0308; G01H 3/08; G10L 25/18; G10L 25/21; G10L 25/30; G10L 25/51

(52) U.S. Cl. CPC G10L 21/0308; G01H 3/08; G10L 25/18; G10L 25/21; G10L 25/30; G10L 25/51

(57) ABSTRACT

There is provided an audio processing system and method comprising an input interface that receives an input audio mixture and transforms it into a time-frequency representation defined by values of time-frequency bins, a processor that maps the values of time-frequency bins into a hyperbolic space by executing an embedding neural network trained to associate each time-frequency bin to a high-dimensional embedding and projecting each high-dimensional embedding into the hyperbolic space, and an output interface that accepts a selection of at least a portion of the hyperbolic space and renders selected hyperbolic embeddings falling within the selected portion of the hyperbolic space.

### TECHNICAL FIELD

The present disclosure relates generally to audio source separation, and more particularly to a method and an apparatus for audio source separation using hyperbolic embeddings for time-frequency bins of a spectrogram of an audio mixture signal.

### BACKGROUND

Diagnosis and analysis of mixture of sound signals requires separation of such signals into sound sources of interest. The field of audio source separation has seen notable performance improvements with the introduction of deep learning techniques, most notably in the areas of speech enhancement, speech separation, and music separation. Specifically, deep learning techniques are used for separating human speech from background noises (or other speech), or isolating specific musical instruments (e.g., vocals, drums, etc.). These techniques succeed in cases where the notion of a source is well defined, such as in the case of speech, where a target is defined as the speech of a single speaker. However, in real-world scenarios, the source may not be well defined and can be complex to process.

For example, in a scenario, a machine is operating in a large plant or factory, while two persons are having a conversation nearby. In this scenario, the machine and the two persons may each be the audio source. In fact, the individual parts of the machine may each be an audio source as well. Thus, segmenting this audio scene is difficult. Existing audio source separation systems typically use fixed and somewhat arbitrary definitions of sources, for example, musical mixtures are typically separated as “vocals,” “bass,” “drums,” and “other.” In particular, existing models allows for separating sound scenes at multiple levels of granularity (e.g., “drum set” vs. “snare drum”, “train” vs. “brake rotor,” etc.), but the models only accounts for global hierarchical structure in terms of sound class labels, not hierarchical structure that may be present in each time-frequency bin of a sound mixture.

Hierarchical and tree-like structures are ubiquitous in many types of audio processing problems such as musical instrument recognition and separation, speaker identification, and sound event detection. However, all of these approaches model the hierarchical information globally by computing a single embedding vector for an entire audio clip.

Audio source separation involves extracting isolated sounds of individual sources from a mixture of sound signals. For example, techniques that learn feature encoders and decoders directly based on waveform signals have achieved impressive performance. However, they lack interpretability compared to techniques based on time-frequency (T-F) representations. To overcome this, algorithms like deep clustering are used to assign embeddings to different sources by learning embedding vectors for each T-F bins. A fundamental problem for these approaches then becomes how to best learn a discriminative embedding for each T-F bin.

Thus, there is a need of an audio source separation technique that solves above-mentioned problems.

### SUMMARY

It is an objective of some embodiments to achieve sound separation of audio sources in an audio mixture. Additionally, or alternatively, it is an object of some embodiments to provide a system and a method that allows a user to select a portion of a hyperbolic space that corresponds to one or more sound sources and listen to an audio corresponding to the selected portion as a separated sound source. It is also an object of some embodiments to segment the hyperbolic space using different hyperbolic hyperplanes learned for each sound class type and allows the user to select individual hyperbolic hyperplanes. Additionally, or alternatively, it is an object of some embodiments to segment the hyperbolic space using different hyperbolic hyperplanes learned for each sound class type and separate the audio mixture into an output signal for each sound class. Additionally, or alternatively, it is an object of some embodiments to separate the audio mixture using certainty filtering. Additionally, or alternatively, it is an object of some embodiments to provide a neural network trained to map and classify embeddings for spectrograms bins or time-frequency (T-F) bins.

Generally, audio mixtures are separated using deep learning techniques in which embeddings are represented in Euclidean space. However, Euclidean spaces lack the ability to infer hierarchical representations from data without distortion.

Some embodiments are based on a realization that hyperbolic spaces may be used instead of Euclidean spaces. For example, the T-F bins are mapped to hyperbolic embeddings and projected into a hyperbolic space using the neural network. In this scenario, a framework is provided for audio source separation using embeddings on a hyperbolic manifold that compactly represent the hierarchical relationship between sound sources and time-frequency features. Using the hyperbolic space, strong hierarchical embeddings are obtained at low embedding dimensions compared to Euclidean embeddings, which can save computational resources during training and inference. Inspired by recent successes modeling hierarchical relationships in text and images with hyperbolic embeddings, the proposed framework obtains a hyperbolic embedding for each time-frequency bin of a mixture signal spectrogram and estimates T-F masks using hyperbolic softmax layers.

Furthermore, in the hyperbolic space, time-frequency regions including multiple overlapping audio sources are embedded towards the center (i.e., the most uncertain region) of the hyperbolic space and the region of the hyperbolic space towards the edge corresponds to audio of a single sound source. This enables visual representation of the mixed audio signal that includes multiple audio sources. The visual representation of the mixed audio signal enables visualization of different audio signals present in the mixed audio signal. From the visual representation of the mixed audio signal and analysis of the hyperbolic space, a certainty estimate of individual sounds may be inferred to efficiently trade-off between artifact introduction and interference reduction when isolating individual sounds.

### Audio Source Selection

For example, in some embodiments, given the hyperbolic embeddings, the classification of these embeddings can be done using an embedding classifier which is a part of the neural network. However, the user is unable to select the classified embeddings as per the requirement. Some embodiments are based on the realization that the user should be able to select specific sound sources.

To that end, some embodiments of the present disclosure discloses an interface that accepts an input from the user to select a region of the hyperbolic space, creates a T-F mask, and apply the created T-F mask on the original mixed audio signal to obtain the separated source corresponding to the selected region of the hyperbolic space. This interface enables visualization of individual sound sources in the mixed audio signal and selection of one or more audio sources to listen using devices such as, but not limited to, a loudspeaker.

### Certainty Filtering

Further, in some embodiments, there is lack of confidence regarding the source of the separated hyperbolic embeddings. Some embodiments are based on the realization that the audio mixture may be separated using certainty filtering. For example, some embodiments of the present disclosure discloses a hyperbolic separation network that performs two-stage source separation using certainty filtering. The certainty filtering uses T-F bins whose learned hyperbolic embeddings are near the edge of the hyperbolic space, as these bins highly likely belong to a single source. The hyperbolic embeddings are filtered using an estimate of a distance of the hyperbolic embeddings from the origin of the hyperbolic space. Hyperbolic embeddings with a larger distance from the origin are more likely to belong to a single audio source and hyperbolic embeddings with a smaller distance from the origin are more likely to include multiple overlapping audio sources. By setting an optimum threshold value of the distance from the origin, the certainty filtering ensures, no interference from the overlapping audio sources.

Accordingly, one embodiment discloses a system comprising an input interface that receives an input audio mixture and transform it into a time-frequency representation defined by values of time-frequency bins, a processor that maps the values of time-frequency bins into a hyperbolic space by executing an embedding neural network trained to associate each time-frequency bin to a high-dimensional embedding and projecting each high-dimensional embedding into the hyperbolic space, and an output interface that accepts a selection of at least a portion of the hyperbolic space and render selected hyperbolic embeddings falling within the selected portion of the hyperbolic space.

Accordingly, another embodiment discloses a method that comprises receiving an input audio mixture and transform it into a time-frequency representation defined by values of time-frequency bins, mapping the values of time-frequency bins into a hyperbolic space by executing an embedding neural network trained to associate each time-frequency bin to a high-dimensional embedding and projecting each high-dimensional embedding into the hyperbolic space, and accepting a selection of at least a portion of the hyperbolic space and render selected hyperbolic embeddings falling within the selected portion of the hyperbolic space.

Accordingly, yet another embodiment discloses, a non-transitory computer-readable storage medium embodied thereon a program executable by a processor for performing a method that comprises receiving an input audio mixture and transform it into a time-frequency representation defined by values of time-frequency bins, mapping the values of time-frequency bins into a hyperbolic space by executing an embedding neural network trained to associate each time-frequency bin to a high-dimensional embedding and projecting each high-dimensional embedding into the hyperbolic space, and accepting a selection of at least a portion of the hyperbolic space and render selected hyperbolic embeddings falling within the selected portion of the hyperbolic space.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of an exemplar network environment for audio source separation using hyperbolic embeddings, in accordance with some embodiment of the disclosure.

FIG. 2 illustrates a block diagram that illustrates an exemplary audio processing system for audio source separation using hyperbolic embeddings, in accordance with some embodiment of the disclosure.

FIG. 3 illustrates a flowchart that illustrates an exemplary method for hyperbolic audio source separation, in accordance with some embodiment of the disclosure.

FIG. 4 illustrates a flow diagram that illustrates operations of an audio processing system for hyperbolic audio source separation, in accordance with some embodiment of the disclosure.

FIG. 5A illustrates a spectrogram that shows time-frequency representation of an audio mixture signal, in accordance with some embodiment of the disclosure.

FIG. 5B illustrates a Poincaré ball that shows a hyperbolic space including classified hyperbolic embeddings, in accordance with some embodiment of the disclosure.

FIG. 6 illustrates a Poincaré ball with decision boundaries, in accordance with some embodiment of the disclosure.

FIG. 7A illustrates an interface for selection of hyperbolic embeddings in hyperbolic space, in accordance with some embodiment of the disclosure.

FIG. 7B illustrates an interface for displaying a masked spectrogram, in accordance with some embodiment of the disclosure.

FIG. 8A illustrates an interface for selection of one or more hyperplanes in hyperbolic space, in accordance with some embodiment of the disclosure.

FIG. 8B illustrates an interface for displaying a masked spectrogram, in accordance with some embodiment of the disclosure.

FIG. 9 illustrates a flow diagram that describes operations of an audio processing system for hyperbolic audio source separation, in accordance with some embodiment of the disclosure.

FIG. 10 illustrates a flow diagram that describes the working of an audio processing system for hyperbolic audio source separation using certainty filtering, in accordance with some embodiment of the disclosure.

FIG. 11 illustrates a flow diagram that describes a hyperbolic separation network, in accordance with some embodiment of the disclosure.

FIG. 12 illustrates a flow diagram that describes an exemplary remote diagnostics application, in accordance with some embodiment of the disclosure.

FIG. 13 illustrates an interface of a control knob for hyperbolic audio source separation, in accordance with some embodiment of the disclosure.

### DETAILED DESCRIPTION

Some embodiments of the present disclosure provide a method and apparatus for audio source separation using hyperbolic embeddings for time-frequency bins of a spectrogram of audio mixture signal. The audio mixture signal includes signals from different audio sources.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

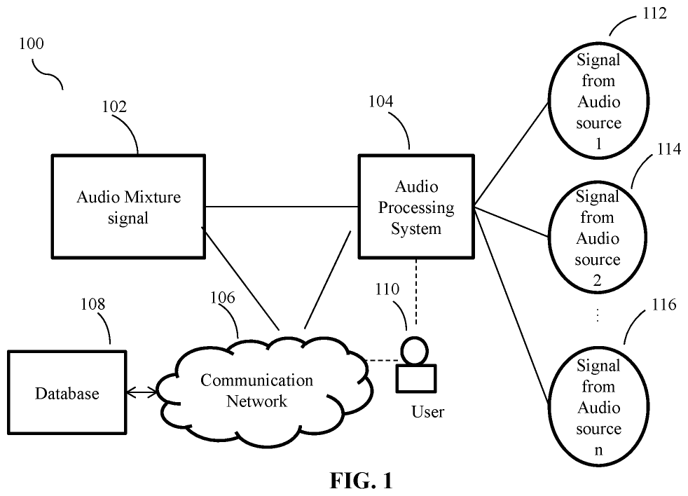

FIG. 1 is a block diagram that illustrates an exemplary network environment for audio source separation using hyperbolic embeddings, in accordance with some embodiment of the disclosure. With reference to FIG. 1, there is shown a network environment 100. The network environment 100 may include multiple sources of sound that results in an audio mixture signal 102. The network environment 100 may further include an audio processing system 104, a communication network 106, and a database 108. In FIG. 1, the audio processing system 104, the communication network 106, and the database 108 are shown as separate devices. However, in some embodiments, the entire functionality of the audio processing system 104, the communication network 106, and the database 108 may be incorporated in the audio processing system 104, without a deviation from the scope of the disclosure.

The audio mixture signal 102 may include audio signals from multiple audio sources. For example, the input audio mixture may comprise sounds of multiple musical instruments such as guitar, piano, drums and other similar instruments. In another example, the network environment 100 may correspond to an audio scene from an industrial site where multiple sounds are originated. The sounds may include, but are not limited to, two persons talking to each other, sounds from different parts of the machine. Specifically, the multiple audio sources are not identifiable in the time domain or spectral domain representation of the audio mixture signal 102.

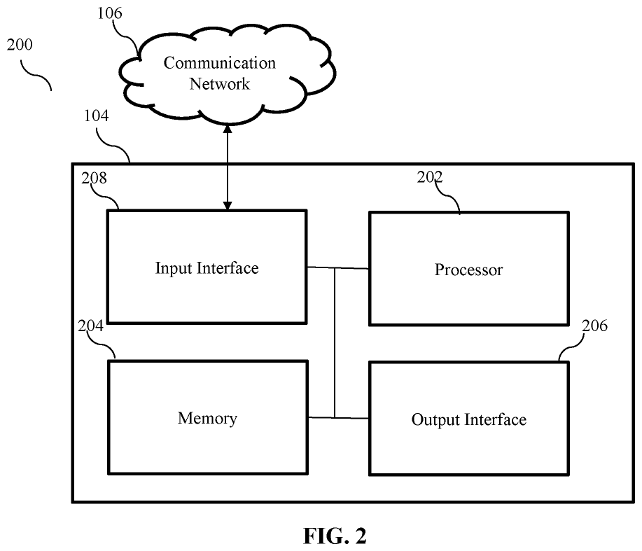

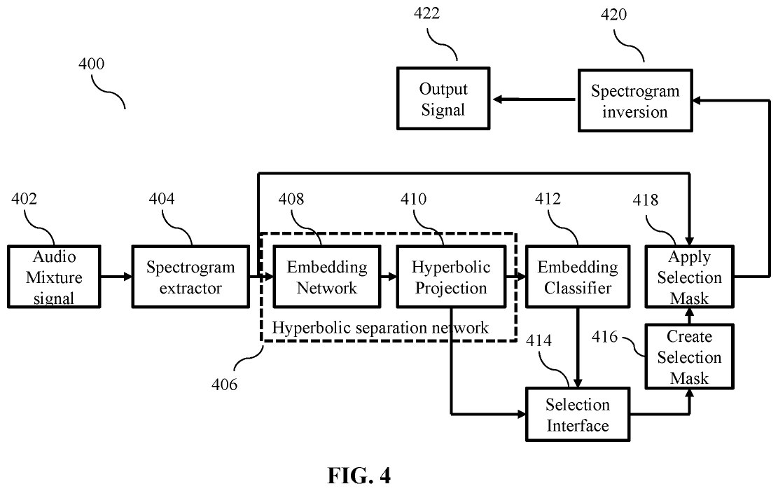

The audio processing system 104 may include suitable logic, circuitry, code, and/or interfaces that may be configured to accept as an input the audio mixture signal 102 and output one or more audio signals as separated audio signals. The one or more separated audio signals may include an audio signal 112 from an audio source 1, an audio signal 114 from an audio source 2, or an audio signal 116 from an audio source n. The underlying technology to extract one or more audio signals 112, 114, 116 from the audio mixture signal 102 is illustrated in detail with reference to FIG. 4. An exemplary audio processing system 104 is illustrated in detail with reference to FIG. 2.

The communication network 106 may include a communication medium through which the audio processing system 104 may communicate with the database 104 and other devices which are omitted from disclosure for the sake of brevity. In an embodiment, the user 110 may provide input to the audio processing system 104 through the communication network 106. The communication network 106 may be one of a wired connection or a wireless connection. Examples of the communication network 106 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 106 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The database 108 may include suitable logic, circuitry, and/or interfaces that may be configured to store the neural network model trained to separate audio sources from the audio mixture signal 102. In another embodiment, the database 108 may store program instructions to be executed by the audio processing system 104. Example implementations of the database 108 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The user 110 may be a person capable of providing input to the audio processing system 104 for audio source separation. The modes of input may include, but are not limited to, touch input, gesture input, or input by pressing some button on a control device linked to the audio processing system 104.

FIG. 2 illustrates a block diagram that describes an exemplary audio processing system for audio source separation using hyperbolic embeddings, in accordance with some embodiment of the disclosure. FIG. 2 is explained in conjunction with elements from FIG. 1. With reference to FIG. 2, there is shown a block diagram 200 of the audio processing system 104. The audio processing system 104 may include a processor 202, a memory 204, an output interface 206, and an input interface 208. The processor 202 may be communicatively coupled to the memory 204, the output interface 206, and the input interface 208. In some embodiments, the output interface 206 may include a display device.

The processor 202 may include suitable logic, circuitry, and/or interfaces that may be configured to execute program instructions associated with different operations to be executed by the audio processing system 102. The processor 202 may include one or more specialized processing units, which may be implemented as an integrated processor or a cluster of processors that perform the functions of the one or more specialized processing units, collectively. The processor 202 may be implemented based on a number of processor technologies known in the art. Examples of implementations of the processor 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store program instructions to be executed by the processor 202. The memory 204 may be further configured to store the trained neural networks such as the embedding neural network or the embedding classifier. Without deviating from the scope of the disclosure, trained neural networks such as the embedding neural network and the embedding classifier may also be stored in the database 108. Example implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The output interface 206 may include suitable logic, circuitry, interfaces, and/or code that may be configured to receive an input and provide an output based on the received input. The output interface 206 may include various input and output devices, which may be configured to communicate with the processor 202. For example, the audio processing system 104 may receive a user input via the input interface 208 to select a region on the hyperbolic space or a hyperplane on the hyperbolic space. Examples of the input interface 208 may include, but are not limited to, a touch screen, a keyboard, a mouse, a joystick, or a microphone.

The input interface 208 may also include suitable logic, circuitry, interfaces, and/or code that may be configured to facilitate the processor 202 to communicate with the database 108 and/or other communication devices, via the communication network 106. The input interface 208 may be implemented by use of various known technologies to support wireless communication of the audio processing system 102 via communication network 106. The input interface 208 may include, for example, an antenna, a radio frequency (RF) transceiver, one or more amplifiers, a tuner, one or more oscillators, a digital signal processor, a coder-decoder (CODEC) chipset, a subscriber identity module (SIM) card, a local buffer circuitry, and the like.

The input interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), or Worldwide Interoperability for Microwave Access (Wi-MAX).

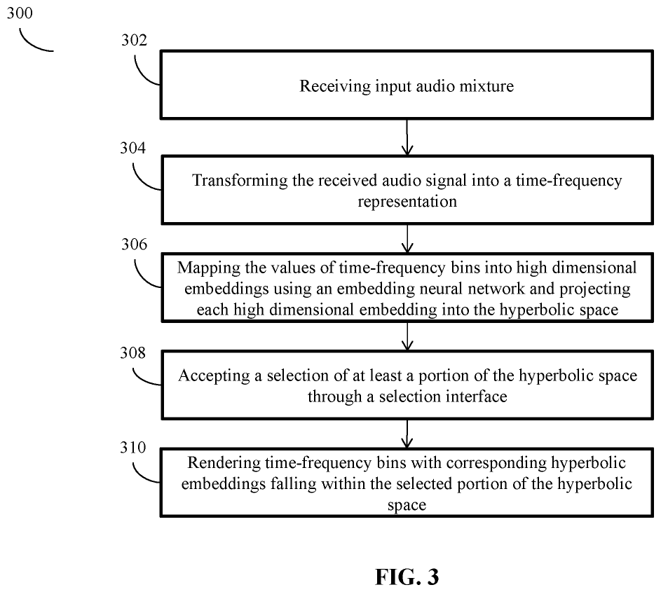

The functions or operations executed by the audio processing system 104, as described in FIG. 1, may be performed by the processor 202. Operations executed by the processor 202 are described in detail, for example, in FIG. 3 and FIG. 4.

FIG. 3 illustrates a flowchart that describes an exemplary method for hyperbolic audio source separation, in accordance with some embodiment of the disclosure. FIG. 3 is explained in conjunction with elements from FIG. 1 and FIG. 2. With reference to FIG. 3, there is shown a flowchart 300. The method illustrated in the flowchart 300 may be executed by any computing system, such as by the audio processing system 104 for separating the audio mixture signal 102 into its multiple audio sources using hyperbolic embeddings. The method may start at 302 and proceed to 310.

At 302, the audio processing system 104 receives the audio mixture signal 102 either directly or through the communication network 106. The audio mixture signal 102 may include audio signals from different sources. A source of the audio signals in the audio mixture signal 102 may be identified by, for example, but not limited to, at least one of a pitch, an amplitude, or a timbre.

At 304, the received audio mixture signal is transformed by the audio processing system 104 into a spectrogram. The spectrogram is a time-frequency representation of the audio mixture signal 102. Alternatively, the spectrogram may be a visual representation of the spectrum of frequencies of a signal as it varies with time. It represents the signal strength, or “loudness”, of a signal over time at various frequencies present in a particular waveform. The spectrogram also allows for visualization of energy levels of the sound over time.

At 306, the audio processing system 104 extracts time-frequency (T-F) bins of the audio mixture signal 102 from the generated spectrogram, maps the T-F bins into high dimensional embeddings using an embedding neural network and project the high dimensional embeddings into the hyperbolic space. Details of the embedding neural network is explained in detail with reference to description of FIG. 4. As an example, the embedding neural network may include, but not limited to, multiple bidirectional long short-term memory (BLSTM) layers, convolutional layers or transformer layers. Each T-F bin goes through the layers of the neural network that convert its time-frequency data into D-dimensional embeddings. These embeddings are then mapped into high dimensional embeddings, or hyperbolic embeddings as per some embodiments of the disclosure.

At 308, the audio processing system 104 accepts a selection of a region of the hyperbolic space from a user. In an embodiment, the user may select a portion of the hyperbolic space using a resizable selection tool. The shape and size of the selection tool depends on a choice of the user. In another embodiment of the disclosure, the user may select an entire hyperbolic hyperplane of the hyperbolic space. In an embodiment, the user may select one or multiple regions on the hyperbolic space. The selection of the region of the hyperbolic space results in selection of hyperbolic embeddings falling within the selected portion of the hyperbolic space.

At 310, the audio processing system 104 renders the selected hyperbolic embeddings. The rendering of the selected hyperbolic embeddings includes transforming the selected hyperbolic embeddings into a separated output audio signal and sending the output audio signal to a loudspeaker.

FIG. 4 illustrates a flow diagram that describes operations of the audio processing system for hyperbolic audio source separation, in accordance with some embodiment of the disclosure. FIG. 4 is explained in conjunction with elements from FIGS. 1, FIG. 2, and FIG. 3. With reference to FIG. 4, there is shown a flow diagram 400. The flow diagram 400 provides description of the operations performed by the audio processing system 104 for audio source separation. With reference to FIG. 1 and FIG. 2, the input interface 208 of the audio processing system 104 may execute functions related to a spectrogram extractor 404. The processor 202 may perform functions associated with a hyperbolic separation network 406 and an embedding classifier 412. The output interface 206 may perform functions related to a selection interface 414, creation 416 of T-F mask, application 418 of T-F mask or a spectrogram inversion 420.

The audio processing system 104 obtains an audio mixture signal 402 from an environment. The environment may include, but not limited to, an industrial sites or factories, smart Al assistants, music concerts and the like where multiple overlapping sound events co-exist. Accordingly, the audio mixture signal 402 comprises sounds from various sources overlapping in time and frequency domain. For example, a machine operating in a large plant or factory, while two people are having a conversation nearby can produce such an audio mixture. This mixture may contain audio from various machine sounds, background noise as well as human sounds. In an embodiment, the audio processing system 104 may include a set of sensors to detect audio signals from different sources in the environment. The set of sensors may include, but are not limited to, microphones such as dynamic microphone, carbon microphone, ribbon microphone, or piezoelectric microphone. The set of sensors provides the audio signals detected from different sources as the audio mixture signal 402 for further processing to spectrogram extractor 404 of the audio processing system 104.

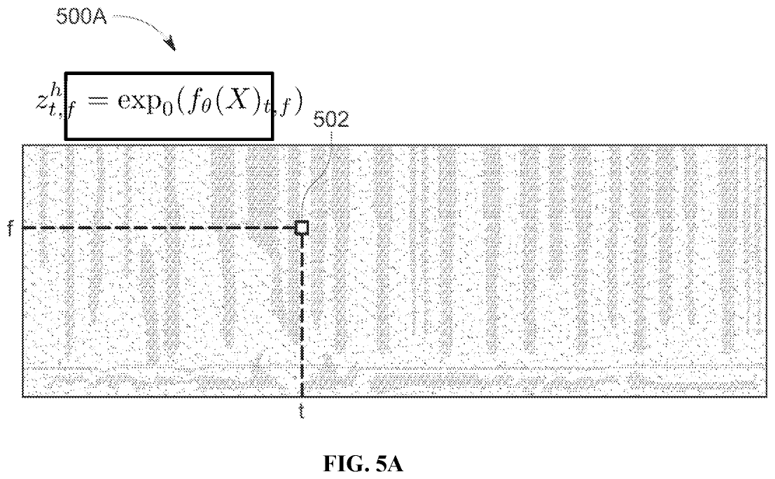

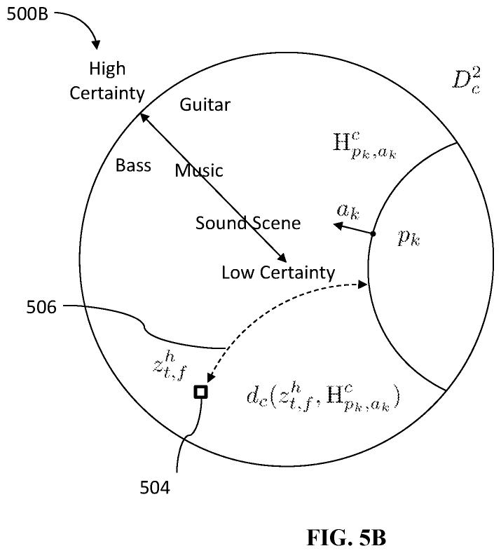

The spectrogram extractor 404 processes the audio mixture signal 402 to convert it into a spectrogram which is a representation of the sound signal in the time-frequency format. A spectrogram is a visual way of representing the signal strength, or loudness of different constituents of the audio mixture signal 402 over time at various frequencies present in the audio mixture signal 402. Details of the spectrogram are explained with reference to description of FIG. 5A that shows the spectrogram 500A generated by the spectrogram extractor 404. The spectrogram 500A of the audio mixture signal 402 is sampled at regular intervals to generate time-frequency (T-F) bins. In an example, the T-F bins represent values of the spectrogram for different instances of time. In FIG. 5A, the T-F bins 502 represent the values of the spectrogram 502. Values of the T-F bins are extracted from spectrogram and provided to a hyperbolic separation network 406 for transforming the extracted values of the T-F bins into hyperbolic embeddings and projecting the hyperbolic embeddings into a hyperbolic space.

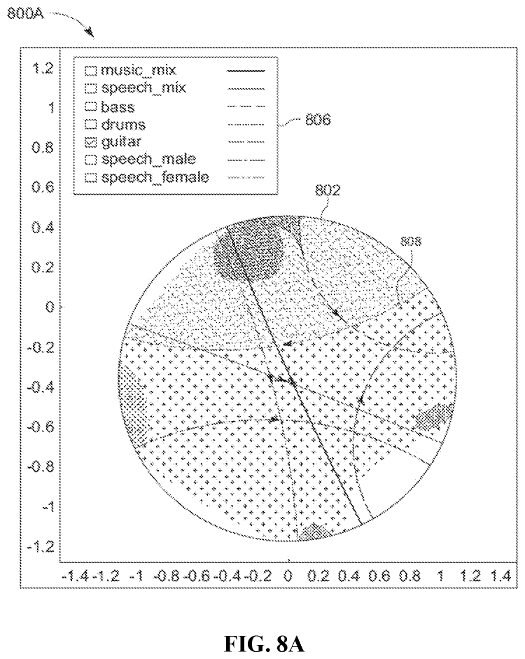

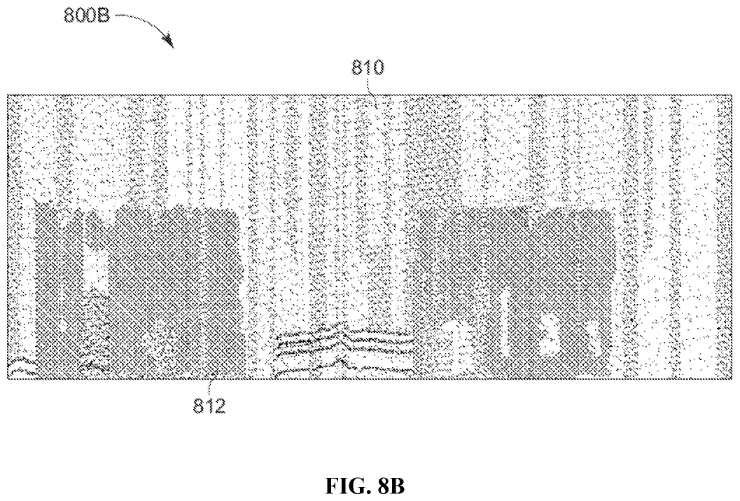

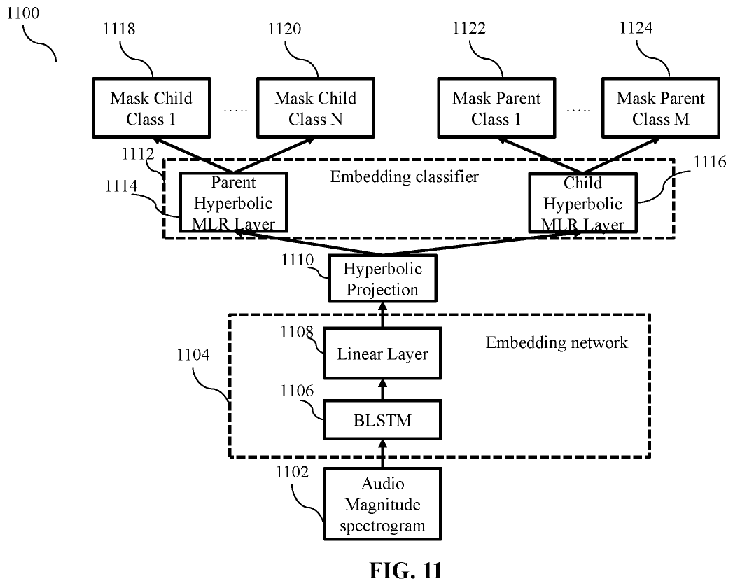

In an embodiment, the hyperbolic separation network 406 comprises an embedding neural network 408 and a hyperbolic projection 410. Without deviating from the scope of the disclosure, in another embodiment, the hyperbolic separation network 406 may additionally comprises an embedding classifier 412. For example, the embedding classifier 412 may be used for automatic segmentation of the hyperbolic space using hyperbolic hyperplanes for different sound classes or audio sources in the audio mixture signal 402 as explained further with reference to description of FIG. 8. In another example, the embedding classifier 412 is used during training and validation of the hyperbolic separation network 406. Details of the training and validation of the embedding neural network 408 are explained with reference to description of FIG. 11.

The embedding neural network 408 takes the T-F bins from the spectrogram as input to its layers and outputs D-dimensional hyperbolic embeddings corresponding the T-F bins. In other words, the embedding neural network 408 is performing transformation of values from time-frequency domain to the hyperbolic space. The embedding neural network 408 may consist of multiple bidirectional long short-term memory (BLSTM) layers, which may be replaced by other deep network layer types such as convolutional layers, transformer layers, etc.

The hyperbolic projection 410 projects the D-dimensional hyperbolic embeddings into the hyperbolic space. The hyperbolic space is represented as a Poincaré ball, as shown in FIG. 5B. A Poincaré ball is a model for hyperbolic geometry in which a line is represented as an arc of a circle whose ends are perpendicular to the disk's boundary (and diameters are also permitted). Two arcs which do not meet correspond to parallel rays, arcs which meet orthogonally correspond to perpendicular lines, and arcs which meet on the boundary are a pair of limits rays.

Each of the hyperbolic embeddings is visually indicated as a dot at a certain location on the Poincaré ball. The location of the hyperbolic embedding on the Poincare ball is calculated based on the audio mixture spectrogram and the value of the corresponding T-F bin. Information associated with each hyperbolic embedding includes information of the original sound corresponding to the T-F bin. Each value on the Poincaré ball includes some information about the original sound or the audio mixture signal 402. Advantageously, the hyperbolic embeddings preserve hierarchical information associated with the original sound while Euclidean embeddings do not. Hierarchical representation in Euclidean space is not very compact and requires lot of space memory wise. On the other hand, representing the hierarchy on Poincaré ball is advantageous since the hyperbolic representation requires less memory and is less computationally extensive since it compactly represents hierarchy. Further, there is an advantage of getting a visual representation of the sound. Compared to non-hierarchical network, lower dimension embedding may be used.

A Riemannian manifold is defined as a pair consisting of a manifold M and a Riemannian metric g, where g=(gₓ)_{x∈M} defines the local geometry gₓ(i.e., an inner product) in the tangent space TₓM at each point x∈M. While g defines the geometry locally on M, it also defines the global shortest path, or geodesic (analogous to a straight line in Euclidean space), between two given points on M. The exponential map expₓ projects any vector v of the tangent space TₓM onto M, such that expₓ(v)∈M, and inversely a logarithmic map projects any point in M back onto the tangent space at x.

The L-dimensional hyperbolic space is an L-dimensional Riemannian manifold of constant negative curvature −c. It can be described using several isometric models, mainly the Poincaré unit ball model (D_{c}^{L}, g_{c}^{D}), defined in the space
D_{c}^{L}={x∈R^{L}|c∥x∥²<1}}. It is assumed that c>0, such that D_{c}^{L} corresponds to a ball of radius

$$\frac{1}{\sqrt{c}}$$

in Euchlucan space. Its Riemannian metric is given by g_{c}^{D}(x)=(λₓ²)²g_{E}, where λₓ^{c}=2/(1−c∥x∥2) is a so-called conformal factor and g^{E} the Euclidean metric. Given two points, y∈D_{c}^{L}, their induced hyperbolic distance d_{c} is obtained as

$${d}_{c} ( x , y ) = \frac{2}{\sqrt{c}} {tanh}^{- 1} ( \sqrt{c} ‖ - x {⊕}_{c} y ‖ ) \qquad ( 1 )$$

where ⊕_{c} denotes the Mobius addition in D_{c}^{L}, defined as:

$$x {⊕}_{c} y = \frac{( 1 + 2 c 〈 x , y 〉 + c {‖ y ‖}^{2} ) x + ( 1 - c {‖ x ‖}^{2} ) y}{1 + 2 c 〈 x , y 〉 + {c}^{2} {‖ x ‖}^{2} {‖ y ‖}^{2}} \qquad ( 2 )$$

One way to go back and forth between the Euclidean space R^{L} and the hyperbolic space D_{c}^{L} is to use the exponential and logarithmic maps at the origin 0, as

T₀D_{c}^{L}=R^{L}, which can be obtained for v∈R^{L}\{0} and y∈D_{c}^{L}\{0} as:

$$\begin{matrix}{exp}_{0}^{c} ( v ) = \frac{tanh ( \sqrt{c} ‖ v ‖ )}{\sqrt{c} ‖ v ‖} v , \\ {log}_{0}^{c} ( v ) = \frac{{tanh}^{- 1} ( \sqrt{c} ‖ y ‖ ) )}{( \sqrt{c} ‖ v ‖ )} y\end{matrix} \qquad ( 3 )$$

Hyperbolic embeddings can be obtained as z_{t,f}^{h}∈D_{c}^{L} at the output of a classical neural network such as f_{θ} by simply projecting the usual Euclidean embeddings in that way:

z_{t,f}^{h}=exp₀(z_{t,f}^{e})=exp₀(f_{θ}(X)_{t,f}) (4)

To define a hyperbolic softmax based on these hyperbolic embeddings, the Euclidean MLR can be generalized to the Poincaré ball. In the Euclidean space, MLR is performed by considering the logits obtained by calculating the distance of an input's embedding z∈R^{L} (such as z=z_{t,f}^{e}) to each of K class hyperplanes, where the k-th class hyperplane is determined by a normal vector aₖ∈R^{L} and a point pₖ∈R^{L} on that hyperplane. Analogously, a Poincaré hyperplane Hₐ_{ₖ}_{,p}_{ₖ}^{c} can be defined by considering the union of all geodesics passing by a point pₖ and orthogonal to a normal vector aₖ in the tangent space TₚₖD_{c}^{L} at pₖ. Hyperbolic MLR can then be defined by considering the distance from a hyperbolic embedding z=z_{t,f}^{d}∈D_{c}^{L} to each Hₐ_{ₖ}_{,p}_{ₖ}^{c}, leading to the following formulation as:

$$p ( κ = k \vert z ) ∝ exp ( \frac{{λ}_{{p}_{k}}^{c} ‖ {a}_{k} ‖}{\sqrt{c}} sinh - 1 ( \frac{2 \sqrt{c} \vert 〈 - p k {⊕}_{c} z , ak 〉 \vert}{( 1 - c {‖ - p k {⊕}_{c} z ‖}^{2} ) ‖ {a}_{k} ‖} ) ) \qquad ( 5 )$$

The probability p(κ=k|z_{t,f}^{d}) that T-F bin (t, f) is dominated by the k-th source can be used to obtain K source-specific mask values for each T-F bin in the input spectrogram X. Both pk and ak parameterize the k-th hyperbolic hyperplane and are trainable. All parameters of the network f_{θ} and of the hyperplanes can be optimized using classical source separation objective functions, either on the masks or on the reconstructed signals.

The hyperbolic projection 410 is a formula to output the embeddings of embedding neural network 408 to the hyperbolic space or the Poincaré ball. In addition to benefits in terms of hierarchical modelling, hyperbolic layers can learn strong embeddings at low dimensions, represent uncertainty based on their distance to the origin in the hyperbolic space.

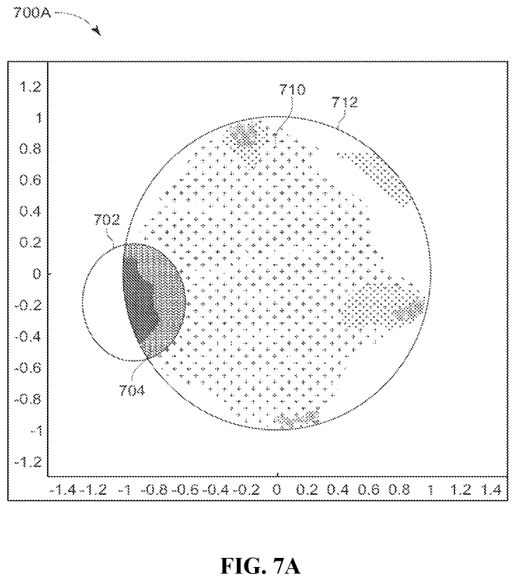

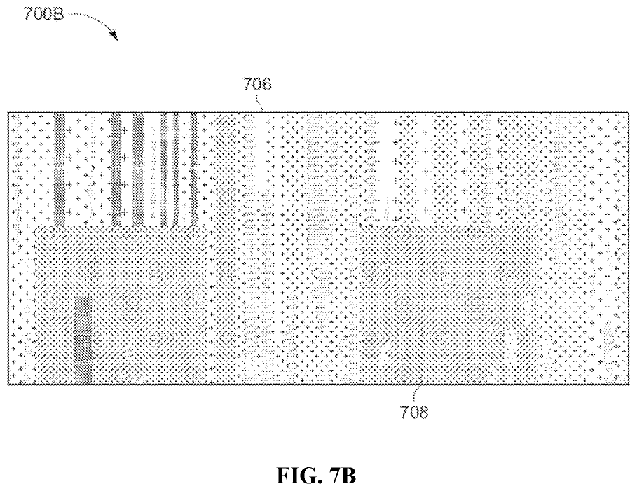

In an embodiment, the audio processing system 104 accepts a user input via the selection interface 414 to select a region of the hyperbolic space. In an example, the user may select a set of hyperbolic embeddings on the hyperbolic space. In another example, the user may select a hyperbolic hyperplane on the hyperbolic space. The hyperbolic hyperplane may correspond to a set of hyperbolic embeddings that belong to a specific sound class. Details of the selection interface 414 that uses a selection tool 702 is explained further with reference to description of FIG. 7A. The selected region of the hyperbolic space may be used to create 416 a T-F mask or selection mask to be applied on the audio mixture spectrogram. In another embodiment, the selection interface 414 may also receive a selection of weight on energy of the hyperbolic embeddings contained in the region selected by the user.

The audio processing system 104 creates 416 the T-F mask using the hyperbolic embeddings corresponding to the selected region on the hyperbolic space based on a softmax operation if a hyperbolic hyperplane corresponding to a specific audio class are selected, or based on a binary mask if a region in the hyperbolic space is selected. A T-F mask is a real-valued matrix of the same size as the spectrogram. The T-F mask may include, but are not limited to, a binary mask or a soft mask. In the binary mask, T-F bins whose embeddings are inside the selected portion of the hyperbolic space have a T-F mask value of 1, and T-F bins with associated embeddings located outside of the selected portion of the hyperbolic space have a T-F mask value of 0. The soft masks take non-binary continuous values. In the case of soft mask, the mask value may include, but not limited to, weights that indicate the distance to the origin of the hyperbolic space, or the distance to nearest classification hyperbolic hyperplane. In another embodiment, weights may depend on the location of the embedding with regards to the hyperplane i.e., same side as center of hyperbolic space or not. In yet another embodiment, the weights may also depend on their location respective to one or more classification hyperbolic hyperplanes. Details of the T-F mask are explained further with reference to description of FIG. 7B.

Once the T-F mask is created, the audio processing system 104 applies the T-F mask to the spectrogram of the audio mixture signal 402 to generate a masked spectrogram of the audio mixture signal 402. In an example, the masked spectrogram of the audio mixture signal 402 includes only those T-F bins which correspond to the hyperbolic embeddings selected by the user at the selection interface 414. Details of the masked spectrogram is explained further with reference to description of FIG. 7B.

The audio processing system 104 applies spectrogram inversion 420 to the masked spectrogram to render an output signal 422 which is a portion of the original audio mixture signal 402 separated from the original audio mixture signal 402. In an example, the output interface 206 of the information processing system 104 may transform the selected hyperbolic embeddings into a separated output audio signal, for example, the output signal 422. The output signal 422 may be an analog signal or a digital signal. In certain embodiment, the audio processing system 104 may send the output signal 422 to a loudspeaker. In another embodiment, the audio processing system 104 may include the loudspeaker.

In certain embodiments, the audio processing system 104 may include an embedding classifier 412 that is trained to classify the hyperbolic embeddings in the hyperbolic space into audio source classes, for example: drums, guitar and trumpet. Details of the classification of the hyperbolic embeddings to the hyperbolic spaces are further explained with reference to description of FIG. 8.

Hierarchical representation is a method of representing data in a tree-like structure, with increase in depth of each level representing increase in features associated with the class. To account for the hyperbolic nature of audio signals, a hierarchical classifier is used, which consists of multiple multinomial logistic regression (MLR) layers, one for each level in the audio sound class hierarchy, consisting of parent and child classes. Two sets of masks are created, one set of N masks, which contains a T-F mask for each of the N child classes, and a second set of M masks containing a mask for each of the M parent classes. For example, the parent classes comprise of labels like speech and music, while the child classes comprise of labels like male speech, female speech, drums and guitar.

After the hyperbolic embeddings are classified within the hyperbolic space, the user can select a specific region of the hyperbolic space using the selection interface 414. In some embodiments of the disclosure, the selection interface may be configured to transform the selected hyperbolic embeddings into a separated output audio signal and send the separated output audio signal to a memory 204, with reference to FIG. 2. The memory 204 may store the separated output signal.

Once the region is selected by the user using the selection interface 414, the audio processing system 104 creates 416 the T-F mask and applies 418 the T-F mask to the spectrogram of the audio mixture signal 402 to generate a masked spectrogram of the audio mixture signal 402. Details of the masked spectrogram is explained further with reference to description of FIG. 7B.

The audio processing system applies spectrogram inversion 916 to the masked spectrogram to render an output signal 918 which is a portion of the original audio mixture signal 902 separated from the original audio mixture signal 902.

In another embodiment, the audio processing system may render the hyperbolic embeddings contained in the selected region by the user based on the weight on the energy of the said hyperbolic embeddings.

The output signal 918 may be an analog signal or a digital signal. In certain embodiment, the audio processing system may send the output signal 918 to a loudspeaker. In another embodiment, the audio processing system may include the loudspeaker.

FIG. 5A illustrates a spectrogram that shows time-frequency representation of an audio mixture signal, in accordance with some embodiment of the disclosure. FIG. 5A is explained in conjunction with elements from FIG. 1, FIG. 2, FIG. 3, and FIG. 4. With reference to FIG. 5A, there is shown a spectrogram 500A of the audio mixture signal 402. As illustrated in FIG. 4, the spectrogram extractor 404 generates a spectrogram X_{t,f}, represented as the spectrogram 500A, for the audio mixture signal 402. The spectrogram 500A displays the strength of different spectral components of the audio mixture signal 402 over time. The spectrogram 500A includes T-F bins as samples of the spectrogram 500A at different instances of time. In an example, a T-F bin 502 represents the energy of the audio mixture signal 402 for spectral component f and at time t. For example, an industrial machine can cause a multitude of varying energy waveforms during operation. Also, the waveform is affected by background noises like machinery and human sounds. The embedding neural network 408 takes the entire spectrogram 500A as input and transforms it into a set of high dimensional embeddings associated with each T-F bin in the spectrogram. For example, the T-F bin 502 is transformed into a hyperbolic embedding z_{t,f}^{h}, represented by the hyperbolic embedding 504, using equation (6).

z_{t,f}^{h}=exp₀(z_{t,f}^{e})=exp₀(f_{θ}(X)_{t,f}) (6)

FIG. 5B illustrates a Poincaré ball that shows a hyperbolic space including classified hyperbolic embeddings, in accordance with some embodiment of the disclosure. FIG. 5B is explained in conjunction with elements from FIG. 1, FIG. 2, FIG. 3, and FIG. 4 and FIG. 5A. With reference to FIG. 5B, there is shown a Poincaré ball 500B that includes projection of the hyperbolic embeddings in the hyperbolic space D_{c}². The hyperbolic space is a Poincaré ball 500B or a Poincaré disk classified according to a hyperbolic geometry that carries a notion of classification hierarchy of audio sources based on locations of the hyperbolic embeddings with respect to an origin of the Poincaré ball 500B or the Poincaré disk. The Poincaré ball 500B represents hyperbolic projection including hyperbolic embeddings corresponding to each T-F bin from the spectrogram 500A. Each T-F bin from the spectrogram 500A is converted to the hyperbolic embeddings and projected to the hyperbolic space D_{c}² represented by the Poincaré ball 500B. For example, the T-F bin 502, as illustrated in FIG. 5A, is converted into the hyperbolic embedding 504 using equation (6) and projected onto the Poincaré ball 500B. In an embodiment, the hyperbolic projection 410 projects the hyperbolic embedding 504 onto the Poincaré ball 500B. The hyperbolic embedding 504, projected onto the Poincaré ball 500B, is at a distance 506 from a hyperplane Hₐ_{ₖ}_{,p}_{ₖ}^{c}. The distance 506 of the hyperbolic embedding 504 from the hyperplane Hₐ_{ₖ}_{,p}_{ₖ}^{c} defines a probability of uncertainty of the hyperbolic embedding 504 to belong to a sound class corresponding to the hyperplane Hₐ_{ₖ}_{,p}_{ₖ}^{c}. Similarly, a distance of the hyperbolic embedding 504 from the origin of the Poincaré ball 500B defines a probability of uncertainty of the hyperbolic embedding 504 to belong to a sound class corresponding to the origin of the Poincaré ball 500B. As a matter of fact, embeddings located near or at the origin of the Poincaré ball 500B represents the sounds which are highly likely to be uncertain or overlapping in nature. In other words, time-frequency regions containing multiple overlapping sources are embedded towards the center (i.e., the most uncertain region) of the Poincare ball 500B. Accordingly, a value of the distance of the hyperbolic embedding 504 from the origin of the Poincaré ball 500B defines a probability of uncertainty or certainty of the hyperbolic embedding 504 to belong to a specific audio class or audio source. In an example, larger the value of the distance of the hyperbolic embedding 504 from the origin of the Poincaré ball 500B, greater is the probability of the hyperbolic embedding 504 to belong to a specific class. Smaller is the value of the distance of the hyperbolic embedding 504 from the origin of the Poincaré ball 500B, smaller is the probability of the hyperbolic embedding 504 to belong to a specific class or higher is the probability of the hyperbolic embedding 504 to include overlapping sound signals. Alternatively, the hyperbolic embeddings on the edge of the Poincaré ball 500B are highly likely to belong to a specific audio class.

The hyperbolic hyperplanes comprises the parameters aₖ and pₖ, which are learned during training of the embedding network using audio data. These are analogous to linear hyperplanes in Euclidean space, e.g., the two-dimensional Euclidean hyperplane is a line. The hyperbolic embeddings are classified into corresponding audio source classes by hyperbolic hyperplanes, which are defined by considering the union of all geodesics passing by a point pk and orthogonal to a normal vector akin the tangent space at pk. Geodesics are locally length-minimizing curves. All the embeddings inside a specific hyperplane may have a higher probability of belonging to that specific audio source class. Embeddings located at the border of hyperplanes may have a mixed waveform. The distance of an embedding from each hyperplanes may also be used to determine their audio source class. In one embodiment, the hyperbolic embeddings located at the edge of the Poincaré ball 500B have a higher certainty of belonging to a class rather than hyperbolic embeddings located at the origin of the Poincaré ball 500B. For example, the embeddings of class guitar located at the edges may have higher certainty of belonging to class guitar than the embeddings of class guitar located near the hyperplane of class guitar towards the origin.

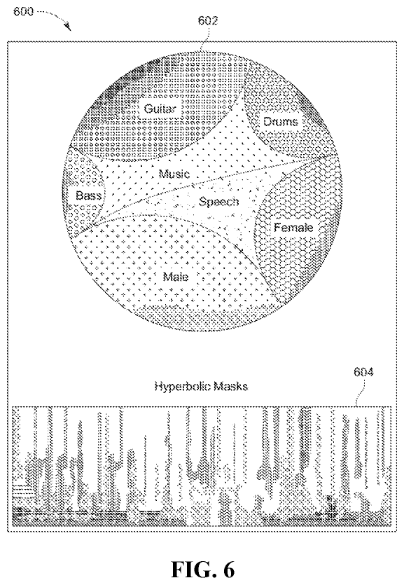

FIG. 6 illustrates a Poincaré ball with decision boundaries, in accordance with some embodiment of the disclosure. FIG. 6 is explained in conjunction with elements from FIG. 1, FIG. 2, FIG. 3, FIG. 4, FIG. 5A, and FIG. 5B. With reference to FIG. 6, there is shown a Poincaré ball 602 and a masked spectrogram 604 for this audio mixture signal represented by the Poincaré ball 602. Each region in the Poincaré ball 602 is defined by a hyperbolic hyperplane and represents the audio source class dominant in it, for example, guitar, drums, bass, male speech, or female speech. The masked spectrogram 604 represents the mask for each individual child class (male speech, female speech, bass, drums, or guitar), that is the position where the corresponding T-F bins located in each hyperbolic region come from. Each hyperbolic hyperplane is marked by a decision boundary. These decision boundaries are learned during the training of the embedding classifier 412. The mixture embeddings (scatters) are represented by different signs or patterns according to the maximum softmax layer output. The predicted T-F masks for each of the audio sources are plotted similarly resulting in the masked spectrogram 604.

FIG. 7A illustrates an interface for selection of hyperbolic space, in accordance with some embodiment of the disclosure. FIG. 7A is explained in conjunction with elements from FIG. 1, FIG. 2, FIG. 3, FIG. 4, FIG. 5A, FIG. 5B, and FIG. 6. With reference to FIG. 7A, there is shown an interface 700A that displays the hyperbolic embeddings 710 projected into the hyperbolic space after classification on a 2-dimensional Poincaré ball 712. The display may include, but not be limited to Cathode-Ray Tube (CRT), Color CRT Monitor, Liquid crystal display (LCD), Light Emitting Diode (LED), Direct View Storage Tubes (DVST), Plasma Display and 3D Display. In an embodiment, the interface 700A may be a part of the selection interface 414, as illustrated in FIG. 4. The interface 700A may include a selection tool 702 operated by a user. The shape of the selection may include, but not limited to, oval, elliptical, square, rectangle, or any polygon. The size of the selection tool 702 may be changed by the user as per the requirement. For example, if the user wants to select a larger region of the hyperbolic space, then the user may provide input to the interface 700A to increase the size of the selection tool 702. The selection tool 702 is resizable and movable, thus, enabling the user to select a customized region from the hyperbolic space to select only high confidence T-F bins for a specific audio source. For example, the user may select embeddings in a region located only on the left edge of the hyperbolic space. The selected embeddings 704 may be the embeddings selected by the user using the selection tool 702. Hence the user has an option listen to separated sources anywhere in the hyperbolic space. Hyperbolic embeddings work better than Euclidean embeddings at low embedding dimensions, e.g., 2D, and the notion of certainty is thus easy to interpret in this interface.

FIG. 7B illustrates an interface for displaying a masked spectrogram, in accordance with some embodiment of the disclosure. FIG. 7B is explained in conjunction with elements from FIG. 1, FIG. 2, FIG. 3, FIG. 4, FIG. 5A, FIG. 5B, FIG. 6, and FIG. 7A. With reference to FIG. 7B, there is shown a display 700B that displays a masked spectrogram 706. In some embodiments. the mask may be of two types: a binary mask where all embeddings of T-F bins located inside the selected portion of the hyperbolic space have a T-F mask value of 1, while all embeddings located outside the selected portion of the hyperbolic space have a T-F mask value of 0. The other type of mask may include a soft mask, where continuous non-binary values in terms of weights represent the distance of the embeddings to the respective nearest classification hyperbolic hyperplane and distance of the embeddings to the origin of the hyperbolic space. After the mask is applied, the T-F bins corresponding to the selected embeddings are highlighted as 708 in the masked spectrogram 706. For example, if the user selected the hyperbolic region dominated by guitar class embeddings, the T-F bins corresponding to guitar class will be highlighted on the masked spectrogram 706. In an example, the interface 700A may provide the selected embedding to the audio processing system 104 which generates a T-F mask 708 using the selected embeddings. The audio processing system 104 may apply the generated T-F mask 708 on the spectrogram of the original audio mixture signal to generate a masked spectrogram 706. The audio processing system 104 applies spectrogram inversion 420 to the masked spectrogram 708 to generate an output signal representing the audio signals corresponding to the selected embeddings 704 on the hyperbolic space.

FIG. 8A illustrates an interface for selection of one or more hyperplanes in hyperbolic space, in accordance with some embodiment of the disclosure. FIG. 8A is explained in conjunction with elements from FIG. 1, FIG. 2. FIG. 3. FIG. 4, FIG. 5A, FIG. 5B, FIG. 6, FIG. 7A, and FIG. 7B. With reference to FIG. 8A, there is shown an interface 800A that displays the hyperbolic embeddings projected into the hyperbolic space after classification on a 2-dimensional Poincaré ball 802. The display may include, but not be limited to Cathode-Ray Tube (CRT), Color CRT Monitor, Liquid crystal display (LCD), Light Emitting Diode (LED), Direct View Storage Tubes (DVST), Plasma Display and 3D Display. In this embodiment, the audio processing system 104 uses the embedding classifier 412 to classify each of the hyperbolic embeddings in the Poincaré ball 802 to one of the different audio class or audio source. For example, the embedding classifier 412 classifies each hyperbolic embedding as belonging to one of the classes such as, but not limited to, guitar, bass, drum, male speech, or female speech. The 2-dimensional Poincaré ball 802 is segmented using learned hyperbolic hyperplanes 808 for each class. In this embodiment, the user may provide input to select one or more hyperplanes as shown by a selection list 806. In another embodiment of the disclosure, the user may move the location of the learned hyperbolic hyperplanes to make different types of selections. In another embodiment of the disclosure, the user may use the selection list 806 to select the hyperbolic audio source required. The selection list may include, but not be limited to a radio button list, check list and drop-down list. After selection, the selected embeddings may be used to create a T-F mask to be applied on the audio mixture spectrogram 810. The separating hyperplanes make it easy to distinguish between the audio sources and the interface lets the user any number of audio sources required.

FIG. 8B illustrates an interface for displaying a masked spectrogram, in accordance with some embodiment of the disclosure. FIG. 8B is explained in conjunction with elements from FIG. 1, FIG. 2, FIG. 3, FIG. 4, FIG. 5A, FIG. 5B, FIG. 6, FIG. 7A, FIG. 7B, and FIG. 8A. With reference to FIG. 8B, there is shown a display 800B that displays a masked spectrogram 810. After the mask is applied, the T-F bins corresponding to the selected embeddings are highlighted as 812 in the masked spectrogram 810. For example, if the user selected the hyperbolic hyperplane corresponding to guitar class embeddings, the T-F bins corresponding to guitar class will be highlighted on the masked spectrogram 810. In an example, the interface 800A may provide the embeddings included in the selected hyperplane to the audio processing system 104 which generates a T-F mask 810 using the embeddings included in the selected hyperplane. The audio processing system 104 may apply the generated T-F mask 812 on the spectrogram of the original audio mixture signal to generate a masked spectrogram 810. The audio processing system 104 applies spectrogram inversion 420 to the masked spectrogram 810 to generate an output signal representing the audio signals corresponding to the embeddings included in the selected hyperplane of the hyperbolic space.

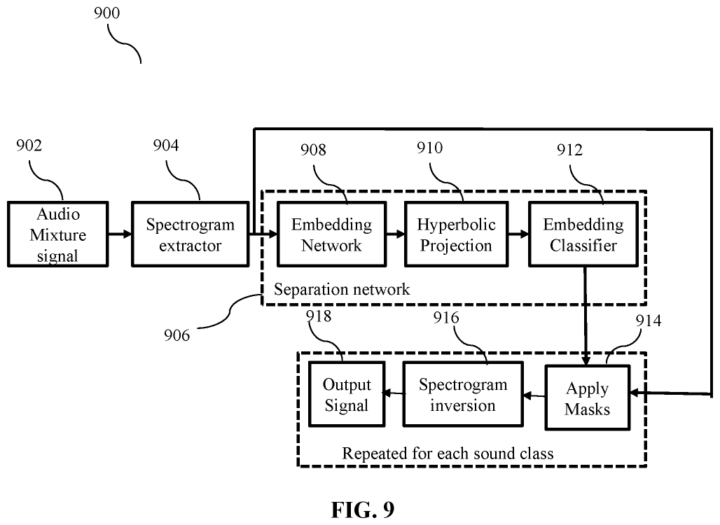

FIG. 9 illustrates a flow diagram that describes operations of an audio processing system for hyperbolic audio source separation, in accordance with some embodiment of the disclosure. FIG. 9 is explained in conjunction with elements from FIG. 1, FIG. 2, FIG. 3, FIG. 4, FIG. 5A, FIG. 5B, FIG. 6, FIG. 7A, FIG. 7B, FIG. 8A, and FIG. 8B. With reference to FIG. 9, there is shown a flow diagram 900 that describes operations performed by the audio processing system 104.

The audio processing system 104 obtains an audio mixture signal 902 from an environment. The environment may include, but not limited to, an industrial sites or factories, smart AI assistants, music concerts and the like where multiple overlapping sound events co-exist. Accordingly, the audio mixture signal 902 comprises sounds from various sources overlapping in time and frequency domain. For example, a machine operating in a large plant or factory, while two people are having a conversation nearby can produce such an audio mixture. This mixture may contain audio from various machine sounds, background noise as well as human sounds. In an embodiment, the audio processing system may include a set of sensors to detect audio signals from different sources in the environment. The set of sensors may include, but are not limited to, microphones such as dynamic microphone, carbon microphone, ribbon microphone, or piezoelectric microphone. The set of sensors provides the audio signals detected from different sources as the audio mixture signal 902 for further processing to spectrogram extractor 904 of the audio processing system.

The spectrogram extractor 904 processes the audio mixture signal 902 to convert it into a spectrogram which is a representation of the sound signal in the time-frequency format. A spectrogram is a visual way of representing the signal strength, or loudness of different constituents of the audio mixture signal 902 over time at various frequencies present in the audio mixture signal 902. Details of the spectrogram are explained with reference to description of FIG. 5A that shows the spectrogram 500A generated by the spectrogram extractor 904. The spectrogram 500A of the audio mixture signal 902 is sampled at regular intervals to generate time-frequency (T-F) bins. In an example, the T-F bins represent values of the spectrogram for different instances of time. In FIG. 5A, the T-F bins 502 represent the values of the spectrogram 502. Values of the T-F bins are extracted from spectrogram and provided to a separation network 906 for transforming the extracted values of the T-F bins into hyperbolic embeddings and projecting the hyperbolic embeddings into a hyperbolic space.

In an embodiment, the separation network 906 comprises an embedding network 908 and a hyperbolic projection 910. Without deviating from the scope of the disclosure, in another embodiment, the separation network 906 may additionally comprises an embedding classifier 912. For example, the embedding classifier 912 may be used for automatic segmentation of the hyperbolic space using hyperplanes for different sound classes or audio sources in the audio mixture signal 902 as explained further with reference to description of FIG. 8. In another example, the embedding classifier 912 is used during training and validation of the separation network 906. Details of the training and validation of the embedding network 908 are explained with reference to description of FIG. 11.

The embedding network 908 takes the T-F bins from the spectrogram as input to its layers and outputs D-dimensional hyperbolic embeddings corresponding to the T-F bins. In other words, the embedding network 908 is performing transformation of values from time-frequency domain to the hyperbolic space.

The hyperbolic projection 910 projects the D-dimensional hyperbolic embeddings into the hyperbolic space.

Each of the hyperbolic embeddings is visually indicated as a dot at a certain location on the Poincaré ball. The location of the hyperbolic embedding on the Poincaré ball is calculated based on the entire spectrogram of the audio mixture signal, and corresponds to a single T-F bin. Information associated with each hyperbolic embedding includes information of the original sound corresponding to the T-F bin. Each value on the Poincaré ball includes some information about the original sound or the audio mixture signal 902.

The hyperbolic projection 910 is a formula to output the embeddings of embedding network 908 to the hyperbolic space or the Poincaré ball. In addition to benefits in terms of hierarchical modelling, hyperbolic layers can learn strong embeddings at low dimensions, and represent uncertainty based on their distance to the origin in the hyperbolic space. Hyperbolic embeddings are generated using the hyperbolic projection 910.

The audio processing system may include an embedding classifier 912 that is trained to classify the hyperbolic embeddings in the hyperbolic space into audio source classes, for example: drums, guitar and trumpet. Details of the classification of the hyperbolic embeddings to the hyperbolic spaces are explained with reference to description of FIG. 8A and FIG. 8B. In an example, the embedding classifier 912 segments the hyperbolic space using hyperbolic hyperplanes according to the classification hierarchy.

Hierarchical representation is a method of representing data in a tree-like structure, with increase in depth of each level representing increase in features associated with the class. To account for the hyperbolic nature of audio signals, a hierarchical classifier is used, which consists of multiple multinomial logistic regression (MLR) layers, one for each level in the audio sound class hierarchy, consisting of parent and child classes.

The masking is done by the audio processing system using the distance of the hyperbolic embeddings from each hyperbolic hyperplane in the hyperbolic space. For example, if a hyperbolic embedding has least distance from the hyperplane of class guitar, its masking will be done corresponding to the audio source class guitar. Two sets of masks are created, one set of N masks, which contains a T-F mask for each of the N child classes, and a second set of M masks containing a mask for each of the M parent classes. For example, the parent classes comprise of labels like speech and music, while the child classes comprise of labels like male speech, female speech, drums and guitar. In an example, a T-F mask is created for each audio class based on the hyperbolic hyperplanes.

Once the masks are created, the audio processing system applies the T-F mask 914 generated for each of the audio class to the spectrogram of the audio mixture signal 902 to generate a masked spectrogram of the audio mixture signal 902.

The audio processing system applies spectrogram inversion 916 to the masked spectrogram to render an output signal 918 for each audio class based on the T-F mask created for a corresponding audio class. The output signals 918 may be an analog signal or a digital signal. In certain embodiment, the audio processing system may send the output signals 918 to a loudspeaker. In another embodiment, the audio processing system may include the loudspeaker.

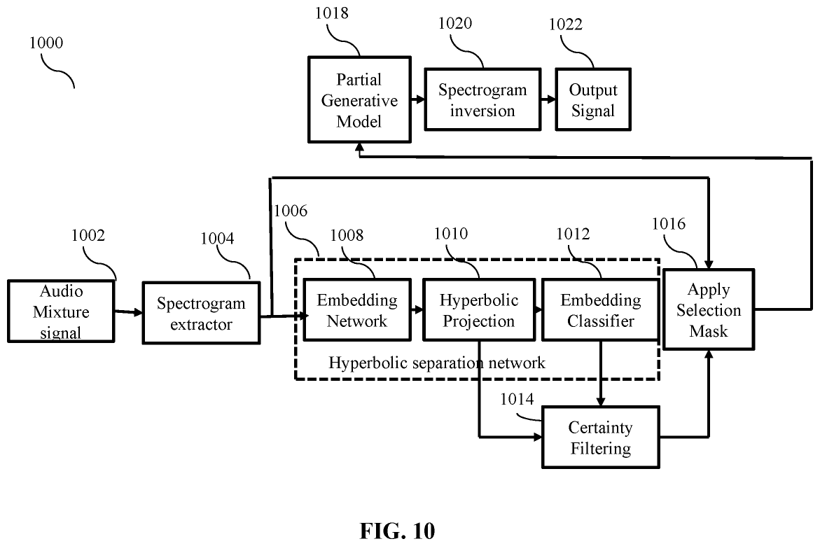

FIG. 10 illustrates a flow diagram that describes the working of the audio processing system for hyperbolic audio source separation using certainty filtering, in accordance with some embodiment of the disclosure. FIG. 10 is explained in conjunction with elements from FIG. 1, FIG. 2, FIG. 3, FIG. 4, FIG. 5A, FIG. 5B, FIG. 6, FIG. 7A, FIG. 7B, FIG. 8A, and FIG. 8B. With reference to FIG. 10, there is shown a flow diagram 1000 that describes the operations performed by the audio processing system 104.

The audio processing system 104 obtains an audio mixture signal 1002 from an environment. The environment may include, but not limited to, an industrial sites or factories, smart AI assistants, music concerts and the like where multiple overlapping sound events co-exist. Accordingly, the audio mixture signal 1002 comprises sounds from various sources overlapping in time and frequency domain. For example, a machine operating in a large plant or factory, while two people are having a conversation nearby can produce such an audio mixture. This mixture may contain audio from various machine sounds, background noise as well as human sounds. In an embodiment, the audio processing system may include a set of sensors to detect audio signals from different sources in the environment. The set of sensors may include, but are not limited to, microphones such as dynamic microphone, carbon microphone, ribbon microphone, or piezoelectric microphone. The set of sensors provides the audio signals detected from different sources as the audio mixture signal 1002 for further processing to spectrogram extractor 1004 of the audio processing system.

The spectrogram extractor 1004 processes the audio mixture signal 1002 to convert it into a spectrogram which is a representation of the sound signal in the time-frequency format. The spectrogram 500A of the audio mixture signal 1002 is sampled at regular intervals to generate time-frequency (T-F) bins. In an example, the T-F bins represent values of the spectrogram for different instances of time. In FIG. 5A, the T-F bins 502 represent the values of the spectrogram 502. Values of the T-F bins are extracted from spectrogram and provided to a hyperbolic separation network 1006 for transforming the extracted values of the T-F bins into hyperbolic embeddings and projecting the hyperbolic embeddings into a hyperbolic space.

In an embodiment, the hyperbolic separation network 1006 comprises an embedding network 1008 and a hyperbolic projection 1010. Without deviating from the scope of the disclosure, in another embodiment, the separation network 1006 may additionally comprises an embedding classifier 1012. For example, the embedding classifier 1012 may be used for automatic segmentation of the hyperbolic space using hyperplanes for different sound classes or audio sources in the audio mixture signal 1002.

The embedding network 1008 takes the T-F bins from the spectrogram as input to its layers and outputs D-dimensional hyperbolic embeddings corresponding to the T-F bins. In other words, the embedding network 1008 is performing transformation of values from time-frequency domain to the hyperbolic space. The embedding network 1008 may consist of multiple bidirectional long short-term memory (BLSTM) layers, which may be replaced by other deep network layer types such as convolutional layers, transformer layers, etc.

The hyperbolic projection 1010 projects the D-dimensional hyperbolic embeddings into the hyperbolic space.

The hyperbolic projection 1010 is a formula to output the embeddings of embedding network 1008 to the hyperbolic space or the Poincaré ball.

The audio processing system may include an embedding classifier 1012 that is trained to classify the hyperbolic embeddings in the hyperbolic space into audio source classes, for example: drums, guitar and trumpet.

The audio processing system performs two-stage source separation using certainty filtering 1014 such that the certainty filtering 1014 is based on certainty information provided by the hyperbolic separation network 1006. In an example, the certainty information is obtained from information associated with the hyperbolic embeddings. The certainty information is based on a number of hyperbolic embeddings near the edge of the Poincare ball. In other words, the certainty information indicates a confidence level of the embedding belonging a specific audio class. In an example, if an embedding belongs to a specific class, it indicates that it is associated with a single audio source. The certainty filtering 1014 is done in two stages. According to some embodiments of the disclosure, a certainty filter may be created using the T-F bins whose learned hyperbolic embeddings are near the edge of the hyperbolic space since these bins highly likely belong to a single audio source. A hyperbolic embedding positioned near an edge of the Poincaré ball or the Poincaré disk corresponds to a more specific audio class on the classification hierarchy than an audio class of a hyperbolic embedding positioned closer to the origin of the Poincaré ball or the Poincaré disk. A distance from the origin of the hyperbolic space to each hyperbolic embedding is used to derive a measure of certainty of the processing, and the creating of the time-frequency mask is based on the measure of certainty of the processing. However, there will be missing information in this separated source as low confidence T-F bins will not be included. Therefore, a state of the art generative model such as those based on diffusion or generative adversarial networks can be used to resynthesize the missing regions of the spectrogram, while ensuring no interference due to the certainty filtering provided by the hyperbolic separation model.

Generative Adversarial Networks, or GANs for short, are an approach to generative modeling using deep learning methods, such as convolutional neural networks. Generative modeling is an unsupervised learning task in machine learning that involves automatically discovering and learning the regularities or patterns in input data in such a way that the model can be used to generate or output new examples that plausibly could have been drawn from the original dataset.

The partial generative model 1018 may be used to resynthesize missing regions of the spectrogram, while ensuring no interference due to the certainty filtering provided by the hyperbolic separation model.

After the certainty filtering 1014 is completed and the missing regions of the spectrogram are predicted partial generative model 1018, the masking is done by the audio processing system using the distance of the hyperbolic embeddings from each hyperbolic hyperplane in the hyperbolic space. For example, if a hyperbolic embedding has least distance from the hyperbolic hyperplane of class guitar, its mask corresponding to the audio source class guitar will have a large value compared to other possible audio source classes. Two sets of masks are created, one set of N masks, which contains a T-F mask for each of the N child classes, and a second set of M masks containing a mask for each of the M parent classes. For example, the parent classes comprise of labels like speech and music, while the child classes comprise of labels like male speech, female speech, drums and guitar.

Once the masks are created, the audio processing system applies the mask 1016 to the spectrogram of the audio mixture signal 1002 to generate a masked spectrogram of the audio mixture signal 1002.

The audio processing system applies spectrogram inversion 1020 to the masked spectrogram to render an output signal 1022 which is a portion of the original audio mixture signal 1002 separated from the original audio mixture signal 1002. The output signal 1022 may be an analog signal or a digital signal. In certain embodiment, the audio processing system may send the output signal 1022 to a loudspeaker. In another embodiment, the audio processing system may include the loudspeaker.

FIG. 11 illustrates a flow diagram that describes a hyperbolic separation network, in accordance with some embodiment of the disclosure. FIG. 11 is explained in conjunction with elements from FIG. 4. With reference to FIG. 11, there is shown a flow diagram 1100 that describes operations performed by the hyperbolic separation network 406 as illustrated in FIG. 4.

The audio processing system obtains a mixed audio signal from an environment, which is converted to an audio magnitude spectrogram 1102 by a spectrogram extractor. The audio magnitude spectrogram 1102 may be used as input for the embedding network 1104. The embedding network 1104 may comprise a Bidirectional Long-Short Term Memory (BLSTM) layer 1106 and a linear layer 1108. In other embodiments of the disclosure, the embedding network 1104 may comprise multiple layers that may include, but not limited to BLSTM layers, convolutional layers, transformer layers and other deep network layers.

Long-Short term Memory (LSTM) based models incorporate “gates” for the purpose of memorizing longer sequences of input data. However, BLSTMs enable additional training by traversing the input data twice i.e., left-to-right and right-to-left. This improves the training of the neural network as the extra memorizing capability accounts for the temporal dependencies present in audio signals.

The training of the hyperbolic separation network may be done using a simple hierarchical source separation dataset containing mixtures from two “parent” classes—music and speech, and five “leaf” classes—bass, drums, guitar, speech-male, and speech-female. As building blocks, the clean subset of LibriSpeech, and Slakh2100 is used which is a dataset of 2,100 synthetic musical mixtures, each containing bass, drums, and guitar stems in addition to various other instruments. A dataset is built consisting of 1947 mixtures, each 60 s in length, for a total of about 32 hours. The data splits are 70%, 20%, and 10% for training, validation, and testing sets, respectively. The speech-male source target consists of male speech utterances randomly picked (without replacement) and concatenated consecutively (without overlap) until the 60 s track length is reached. Any signal from the last concatenated utterance exceeding that length is discarded. The same procedure is used for female speech. For Slakh2100, only the first 60 s of the bass, drums, and guitar stems are selected for each track. Any tracks with a duration less than 60 s are discarded. All sources are summed without applying additional gains to make the overall mixture along with the speech and music sub mixes. This leads to challenging input SDR values, with standard deviation values ranging from 2-13 dB depending on the class.

The model consists of four BLSTM layers with 600 units in each direction, followed by a dense layer to obtain an L-dimensional Euclidean embedding for each T-F bin. A dropout of 0.3 is applied on the output of each BLSTM layer, except the last. For the hyperbolic models (c>0), an exponential projection layer is placed after the dense layer, mapping the Euclidean embeddings onto the Poincare ball with curvature −c. MLR layers, either Euclidean or hyperbolic with softmax activation functions are then used to obtain masks for each of the source classes. The hierarchical softmax approach is followed and there are two MLR layers: one with K=2 for the parent (speech/music) sources, and a second with K=5 for the leaf classes. The mixture phase is used for resynthesis and comparison with multiple training objectives. The ADAM optimizer is used for Euclidean parameters, and the Riemannian ADAM implementation from geoopt is used for hyperbolic parameters. All models are trained using chunks of 3.2 s and a batch size of 10 for 300 epochs using an initial learning rate of 10-3, which is halved if the validation loss does not improve for 10 epochs. An STFT size of 32 ms is used with 50% overlap and square-root Hann window.

Time-frequency (T-F) bins are taken from the audio magnitude spectrogram 1102 and used as input to the BLSTM layer 1106 of the embedding network 1104. The BLSTM layer 1106 memorizes the audio information of the corresponding T-F bin and computes an L-dimensional Euclidean embedding using deep learning. Euclidean spaces lack the ability to infer hierarchical representations from data without distortion. Hence, hyperbolic spaces are used instead of Euclidean spaces. Using hyperbolic space, strong hierarchical embeddings are obtained at low embedding dimensions compared to Euclidean embeddings, which can save computational resources during training and inference.

The linear layer 1108 then converts the BLSTM output into a D-dimensional embedding for each T-F bin. These D-dimensional embeddings are used as input for the hyperbolic projection 1110.

The embedding network 1104 is connected with hyperbolic network layers: a hyperbolic projection 1110 and an embedding classifier 1112 to learn and classify hyperbolic embeddings.

The hyperbolic projection 1110 takes the D-dimensional embeddings and projects them as hyperbolic embeddings onto a hyperbolic space in a Poincaré ball representation as mentioned in FIG. 5B.

The embedding classifier 1112 uses hierarchical classification to classify the embeddings into audio source classes accounting for the hyperbolic nature of audio signals. Hierarchical representation refers to tree-like representation of the data where numbers of features associated with the data increase on increasing the depth of the tree.

Multinomial logistic regression is a classification method that generalizes logistic regression to multiclass problems, i.e. with more than two possible discrete outcomes. It is a model that is used to predict the probabilities of the different possible outcomes of a categorically distributed dependent variable, given a set of independent variables (which may be real-valued, binary-valued, categorical-valued, etc.).

For classification, the embedding classifier 1112 comprises multiple multinomial logistic regression (MLR) layers, one for each level in the audio sound class hierarchy: the parent hyperbolic MLR layer 1114 and the child hyperbolic MLR layer 1116. The child layer may include classes such as male speech, female speech, guitar and drums, and the parent class may include classes such as speech and music.

The MLR layers in the embedding classifier 1112 classify the hyperbolic embeddings using a softmax function which uses distance of a hyperbolic embedding from each hyperbolic hyperplane in the Poincaré ball, mentioned in description of FIG. 5B to determine which class the T-F bin corresponding to the hyperbolic embedding belongs to (parent class or child class).

After classification through the MLR layers, the embedding classifier 1112 creates two sets of masks: one set of N masks, which includes a T-F mask for each of the N child classes, and a second set of M masks including a mask for each of the M parent classes. The probability of an embedding being dominated by an audio source is used to obtain source-specific masks for each T-F bin in the input spectrogram through clustering methods. For example, if a number of embeddings have high probability of belonging to guitar audio source, they may be clustered together to form a T-F mask for the class guitar.

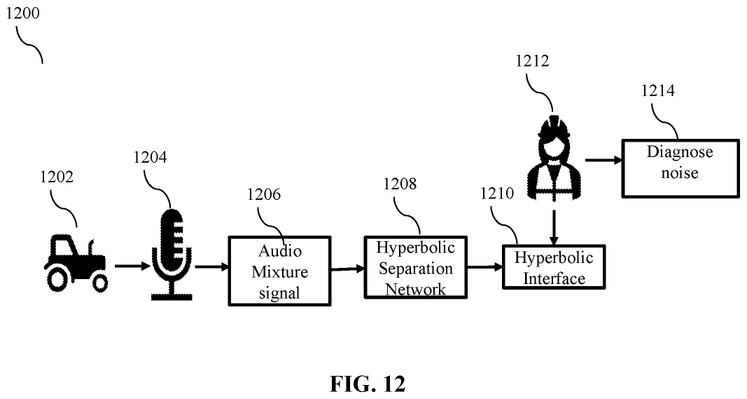

FIG. 12 illustrates a flow diagram that illustrates an exemplary remote diagnostics application, in accordance with some embodiment of the disclosure. FIG. 12 is explained in conjunction with elements from FIG. 1, FIG. 2, FIG. 3, FIG. 4, FIG. 5A, FIG. 5B, FIG. 6, FIG. 7A, FIG. 7B, FIG. 8A, FIG. 9, and FIG. 11. With reference to FIG. 12, there is shown a flow diagram 1200 that describes a working model of the exemplary remote diagnostics application. In an example, the flow diagram 1200 describes an application of the audio processing system 104 for anomaly detection in an audio signal.

A machine 1202 may be considered for remote audio diagnosis. The machine 1202 may include, but not be limited to manufacturing units, vehicles, tractors and large-scale industrial units. The audio signals from the machine 1202 may be recorded using a recorder 1204. The recorder 1204 may comprise an audio recording system with microphones and databases to store an audio mixture signal 1206. The audio mixture signal 1206 may include audio signals generated by the machine 1202 and other audio sources as well.

The audio mixture signal 1206 is then used as input by the hyperbolic separation network 1208 of the audio processing system. The signal may be sent directly or through a communication network as mentioned in FIG. 1. The spectrogram extractor produces a spectrogram of the audio mixture signal 1206.

The hyperbolic separation network 1208 takes each T-F bin from the spectrogram, embeds each T-F as the hyperbolic embedding using the underlying embedding neural network, and projects each hyperbolic embedding onto the hyperbolic space, as mentioned in FIG. 11. As an example, the hyperbolic embeddings located near or at the origin of the hyperbolic space represents the sounds which are highly likely to be uncertain or overlapping in nature. In other words, time-frequency regions containing multiple overlapping sources are embedded towards the center (i.e., the most uncertain region) of the hyperbolic space. Accordingly, a value of a distance of the hyperbolic embeddings from the origin of the hyperbolic space defines a probability of uncertainty or certainty of the hyperbolic embeddings to belong to a specific audio class or audio source.

A hyperbolic interface 1210 may be provided to the user 1212 to use hyperbolic projection of the hyperbolic embeddings produced by the hyperbolic separation network 1208 and select the embeddings corresponding to the T-F bins of user-preferred choice, as mentioned in FIG. 7 and FIG. 8. Once the selection has been made, a T-F mask is applied to the original audio mixture spectrogram to produce the masked spectrogram. The masked spectrogram is inverted to obtain a separated source signal, or a sound signal corresponding to the selection. The separated audio signal is provided as output to diagnose noise 1214 by the user 1212.

In another embodiment, the hyperbolic interface may be used by the user to detect anomalies in the audio mixture signal 1206. For example, the user 1212 may visualize if most of the hyperbolic embeddings are clustered near the origin of the hyperbolic space, then it can be inferred that the audio mixture signal 1206 includes mostly overlapping sounds. This may be considered as anomalous sound. In another example, if the user 1212 visualizes that most of the hyperbolic embeddings are clustered near the edges of the hyperbolic space, then it can be inferred that the audio mixture signal 1206 includes mostly non-overlapping sounds. This may indicate that the audio mixture signal 1206 includes sounds from different sources which can be listened separately, thus, non-overlapping in nature.

In another embodiment, the hyperbolic interface 1210 may determine the input audio mixture as an anomalous sound based on a number of the hyperbolic embeddings located within a threshold distance from the origin of the Poincaré ball or the Poincare disk is greater than or equal to a threshold value. A value of the threshold distance of a hyperbolic embedding from the origin, to consider that hyperbolic embedding belongs to a specific audio class, is predetermined or may be determined during the training of the embedding classifier 1112 as illustrated with reference to description of FIG. 11. Further, the threshold value of the number of the hyperbolic embeddings, to infer that the input audio mixture is not an anomalous sound, is predetermined or may be determined during the training of the embedding classifier 1112 as illustrated with reference to description of FIG. 11.

In yet another embodiment, the inference regarding the detection of anomaly in the audio mixture signal 1206 may be performed automatically without user interference. For example, the audio processing system 104 may detect location of each of the hyperbolic embeddings in the hyperbolic space displayed using the hyperbolic interface 1210. Using the location of each of the hyperbolic embeddings in the hyperbolic space, the audio processing system 104 may determine a pattern of distribution of the hyperbolic embeddings in the hyperbolic space. Using the pattern of distribution of the hyperbolic embeddings in the hyperbolic space, the audio processing system 104 may infer that the audio mixture signal 1206 includes mostly overlapping sounds if most of the hyperbolic embeddings are clustered near the origin of the hyperbolic space. In another example, if most of the hyperbolic embeddings are clustered near the edges of the hyperbolic space, then the audio processing system 104 infers that the audio mixture signal 1206 includes mostly non-overlapping sounds.

In another embodiment, the audio processing system 104 detects an anomaly in the machine 1202 based on a number of the hyperbolic embeddings located within a threshold distance from the origin of the Poincaré ball or the Poincaré disk is greater than or equal to a threshold value. A value of the threshold distance of a hyperbolic embedding from the origin, to consider that hyperbolic embedding belongs to a specific audio class, is predetermined or may be determined during the training of the embedding classifier 1112 as illustrated with reference to description of FIG. 11.

Accordingly, the audio processing system 104 is able to detect anomaly based on distance of the embeddings from the origin of the hyperbolic space. Further, the hyperbolic interface 1210 provides a visual representation of the sound which makes it easier to represent the hierarchy of the individual components present in the audio mixture signal 1206. In an embodiment, the processor 202 of the audio processing system 104 may control the machine 1202 based on the detected anomaly in the machine 1202.

Amongst the many advantageous aspects, the hyperbolic audio source separation provides for visualization of sound, natural way to estimate certainty of classified values, and more compact representation.

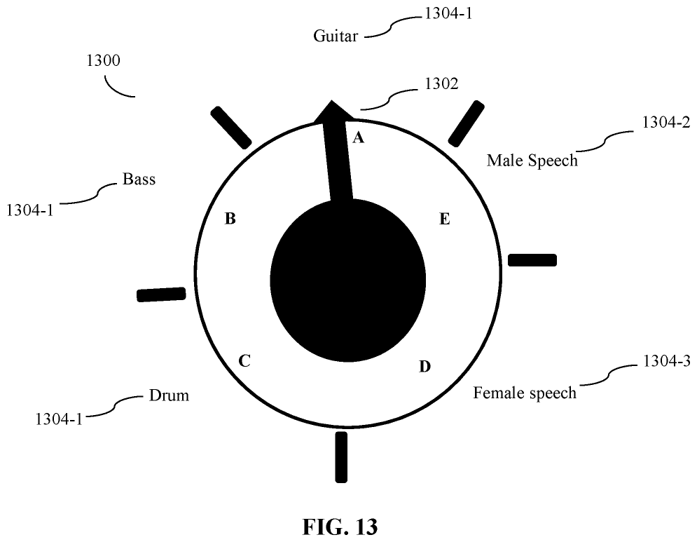

FIG. 13 illustrates a control knob for hyperbolic audio source separation, in accordance with some embodiment of the disclosure. FIG. 13 is explained in conjunction with elements of FIG. 1, FIG. 2, FIG. 3, FIG. 4, FIG. 5A, FIG. 5B, FIG. 6, FIG. 7A, FIG. 7B, FIG. 8A, FIG. 9, FIG. 11, and FIG. 12. With reference to FIG. 13, there is shown a control knob 1302. In some embodiments, the control knob 1302 may also act as a zoom control knob. A position of the zoom control knob 1302 is translated to mixing weights for audio zooming, in accordance with an example embodiment. The zoom control knob 1302 is used to select a specific audio source or a sound class from an audio mixture signal including audio from different sources. In this embodiment, the user may provide input to select one or more audio sources as separated by the embedding classifier 1112. As an example of the user input, the user may move the position of the knob 1302 towards any of the points A-E. The position of control knob 1302 may indicate selection of embeddings included in a hyperplane corresponding to a specific audio class or audio source. In an example, when the user moves the control knob 1302 to a position A, a T-F mask for the embeddings included in a hyperplane corresponding to guitar is created, masked spectrogram is created based on the created T-F mask, and separated sound signal corresponding to class guitar is outputted after spectrogram inversion. In another example, when the user moves the control knob 1302 to a position B, a T-F mask for the embeddings included in a hyperplane corresponding to bass is created, masked spectrogram is created based on the created T-F mask, and separated sound signal corresponding to class bass is outputted after spectrogram inversion. In another example, when the user moves the control knob 1302 to a position C, a T-F mask for the embeddings included in a hyperplane corresponding to drum is created, masked spectrogram is created based on the created T-F mask, and separated sound signal corresponding to class drum is outputted after spectrogram inversion. In another example, when the user moves the control knob 1302 to a position D, a T-F mask for the embeddings included in a hyperplane corresponding to female speech is created, masked spectrogram is created based on the created T-F mask, and separated sound signal corresponding to class female speech is outputted after spectrogram inversion. In another example, when the user moves the control knob 1302 to a position E, a T-F mask for the embeddings included in a hyperplane corresponding to male speech is created, masked spectrogram is created based on the created T-F mask, and separated sound signal corresponding to class male speech is outputted after spectrogram inversion.

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments. The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

We claim:

1. An audio processing system, comprising:
an input interface configured to receive an input audio mixture and transform it into a time-frequency representation defined by values of time-frequency bins;
a processor configured to map the values of time-frequency bins into a hyperbolic space by executing an embedding neural network trained to associate each time-frequency bin to a high-dimensional embedding and projecting each high-dimensional embedding into the hyperbolic space; and
an output interface configured to accept a selection of at least a portion of the hyperbolic space and render selected hyperbolic embeddings falling within the selected portion of the hyperbolic space.

2. The audio processing system of claim 1, wherein
to render the selected hyperbolic embeddings, the output interface is further configured to transform the selected hyperbolic embeddings into a separated output audio signal and send the separated output audio signal to a memory, and
the memory stores the separated output signal.

3. The audio processing system of claim 2, wherein the output interface is further configured to send the separated output signal to a loudspeaker.

4. The audio processing system of claim 1, wherein the output interface is further configured to transform the selected hyperbolic embeddings into a separated output audio signal by creating a time-frequency mask based on the selected hyperbolic embeddings and applying the time-frequency mask to the time-frequency representation of the input audio mixture.

5. The audio processing system of claim 4, wherein the output interface is further configured to create the time-frequency mask based on a softmax operation.

6. The audio processing system of claim 1, wherein the hyperbolic space is a Poincaré ball or a Poincaré disk classified according to a hyperbolic geometry that carries a notion of classification hierarchy of audio sources based on locations of the hyperbolic embeddings with respect to an origin of the Poincaré ball or the Poincaré disk.

7. The audio processing system of claim 6, wherein a distance from the origin of the hyperbolic space to each hyperbolic embedding is used to derive a measure of certainty of the processing, and the creating of the time-frequency mask is based on the measure of certainty of the processing.

8. The audio processing system of claim 6, wherein the processor is further configured to determine, based on a distance of a hyperbolic embedding from the origin of the Poincare ball or the Poincaré disk, a measure of certainty of the hyperbolic embedding to belong to only a single specific audio class on the classification hierarchy.

9. The audio processing system of claim 6, wherein the processor is further configured to determine the input audio mixture as an anomalous sound based on a number of the hyperbolic embeddings located within a threshold distance from the origin of the Poincaré ball or the Poincaré disk is greater than or equal to a threshold value.

10. The audio processing system of claim 6, wherein
the input audio mixture is generated by components of a machine,
the processor is further configured to detect an anomaly in the machine based on a number of the hyperbolic embeddings located within a threshold distance from the origin of the Poincaré ball or the Poincaré disk is greater than or equal to a threshold value.

11. The audio processing system of claim 10, wherein the processor is further configured to control the machine based on the detected anomaly in the machine.

12. The audio processing system of claim 1, wherein the hyperbolic space is classified according to a classification hierarchy of audio sources, and wherein the embedding neural network is trained end-to-end with a classifier trained to classify the hyperbolic embeddings according to the classification hierarchy.

13. The audio processing system of claim 1, wherein the output interface is operatively connected to a display device configured to display a visual representation of the hyperbolic embeddings mapped to different locations of the hyperbolic space to enable the selection of the portion of the hyperbolic space.

14. The audio processing system of claim 1, wherein
training data set for training the embedding neural network includes an audio mixture of at least two parent classes and at least five child classes,
the at least two parent classes include music and speech, and
the at least five child classes include bass, drum, guitar, speech-male, and speech-female.

15. The audio processing system of claim 1, wherein
the processor is further configured to receive a user input, and
a size and a shape of the selected portion of the hyperbolic space is based on the received user input.

16. The audio processing system of claim 12, wherein
the classifier segments the hyperbolic space using hyperbolic hyperplanes according to the classification hierarchy, and
the output interface is further configured to create a T-F mask for each audio class based on the hyperbolic hyperplanes.

17. The audio processing system of claim 16, wherein the output interface is further configured to generate an output signal for each audio class based on the T-F mask created for a corresponding audio class.

18. The audio processing system of claim 1, wherein the processor is further configured to:
accept a selection of weight on energy of the selected hyperbolic embeddings; and
render the selected hyperbolic embeddings based on the weight on the energy of the selected hyperbolic embeddings.

19. An audio processing method, comprising:
receiving an input audio mixture and transform it into a time-frequency representation defined by values of time-frequency bins;
mapping the values of time-frequency bins into a hyperbolic space by executing an embedding neural network trained to associate each time-frequency bin to a high-dimensional embedding and projecting each high-dimensional embedding into the hyperbolic space; and
accepting a selection of at least a portion of the hyperbolic space and rendering selected hyperbolic embeddings falling within the selected portion of the hyperbolic space.

20. A non-transitory computer-readable storage medium embodied thereon a program executable by a processor for performing a method, comprising:
receiving an input audio mixture and transform it into a time-frequency representation defined by values of time-frequency bins;
mapping the values of time-frequency bins into a hyperbolic space by executing an embedding neural network trained to associate each time-frequency bin to a high-dimensional embedding and projecting each high-dimensional embedding into the hyperbolic space; and
accepting a selection of at least a portion of the hyperbolic space and render selected hyperbolic embeddings falling within the selected portion of the hyperbolic space.
